(19) United States
(12) Patent Application Publication
(10) Pub. No.: US 2024/0161047 A1
(43) Pub. Date: May 16, 2024

(54) COMPUTER-BASED SUPPLY CHAIN OPTIMIZATION

(71) Applicant: International Business Machines Corporation, Armonk, NY (US)

(72) Inventors: Shikhar Kwatra, San Jose, CA (US); Jeremy R. Fox, Georgetown, TX (US); Raghuveer Prasad Nagar, Kota (IN); Pradeep Kumar Katherapally, Yemmiganur (IN)

(21) Appl. No.: 18/055,809

(22) Filed: Nov. 15, 2022

(51) Int. Cl. G06Q 50/28; G06Q 10/0631

(52) U.S. Cl. CPC G06Q 50/28; G06Q 10/06316

(57) ABSTRACT

In an approach to improve computer-based supply chain management embodiments of the present invention receive a first order associated with a user, and determine, within predetermine range of confidence, that a second order associated with the user will be received within a predefined timeframe. Additionally, embodiments delay the shipment of the first order, for a predetermined amount of time, based on the determination the second order will be received and execute a hold command that withholds the first order from a distribution center for a predetermined amount of time. Further, responsive to receiving the second order within the predefined timeframe, embodiments consolidate the first order and second order into a consolidated order.

### BACKGROUND OF THE INVENTION

The present invention relates generally to supply chain environments, and more particularly to the field of improving computer-based supply chain management.

In commerce, supply chain management (SCM) is the management of the flow of goods and services between businesses and locations. This can include the movement and storage of raw materials, work-in-process inventory, finished goods, and end to end order fulfilment from the point of origin to the point of consumption. Interconnected, interrelated, or interlinked networks, channels and node businesses combine in the provision of products and services required by end customers in a supply chain. SCM is the centralized management of the flow of goods and services and includes all processes that transform raw materials into final products. By managing the supply chain, companies can cut excess costs and deliver products to the consumer faster and more efficiently. Good supply chain management keeps companies out of the headlines and away from expensive recalls and lawsuits. The five most critical elements of SCM are developing a strategy, sourcing raw materials, production, distribution, and returns. Artificial intelligence (AI)-based supply chain optimization and automation solution that helps improve supply chain resiliency, increase agility, and optimize operations.

### SUMMARY

Embodiments of the present invention disclose a computer-implemented method, a computer program product, and a system, for consolidating two or more shipments, the computer-implemented method comprising: receiving a first order associated with a user; determining, within predetermine range of confidence, that a second order associated with the user will be received within a predefined timeframe; delaying the shipment of the first order, for a predetermined amount of time, based on the determination the second order will be received, wherein delaying the shipment of the first order comprises: executing a hold command that withholds the first order from a distribution center for a predetermined amount of time; and responsive to receiving the second order within the predefined timeframe, consolidating the first order and second order into a consolidated order.

### BRIEF DESCRIPTION OF THE DRAWINGS

FIG. 1A is a functional block diagram illustrating a distributed data processing environment, executing a supply chain optimization program, in accordance with an embodiment of the present invention;

FIG. 1B illustrates a functional block diagram and operational steps of the supply chain optimization program, on a server computer within the distributed data processing environment of FIGS. 1A, in accordance with an embodiment of the present invention; and

FIG. 2 illustrates operational steps of the supply chain optimization program, on a server computer within the distributed data processing environment of FIGS. 1A, in accordance with an embodiment of the present invention.

### DETAILED DESCRIPTION

Embodiments of the present invention recognize that customers may place multiple orders in a short duration of time due to several reasons like, but not limited to, forgotten product(s) in a previous order, availability of the product based on inventor or promotional discounts, and to use methods of payments. Whatever the reasons may be, multiple orders result in more shipping costs and use of resources. Embodiments recognize that a method to enable a system to predict whether a user (e.g., customer) may place multiple orders, and accordingly consolidate the shipments belonging to a previously placed order and/or an expected-to-be-placed order is needed. The sellers and/or retailers possess insight on the customer order history, calendar events, and crisis in the ship to locations. Such insights can be used for any further improvement and efficiency of shipment consolidations.

For example, a user places a first order (order 1) around 10:00 pm on May 4, 2021, for body wash and shampoo from an online shopping platform, with a next day delivery option, and subsequently the user places a second order (order 2) for hair conditioner around one hour after the placement of order 1 from the same online shopping platform with a next day delivery option. Additionally, the user places a third order (order 3) the following morning around 7:00 am from the same online shopping platform with a next day delivery option. Embodiments recognize that these orders will be shipped individually, as the shipping party (e.g., distribution/fulfillment center, shipping service provider, etc.) desires to ship the products out of their warehouse quickly. Additionally, embodiments of the present invention recognize that historical data and other purchases are not generally considered to minimize the number of shipments.

Embodiments of the present invention improve the art and solve at least the issues stated above by predicting, within a predetermined degree of confidence, that one or more subsequent orders will be placed within a predetermined time threshold after an initial order has been placed and holding the shipment of the initial order so that that the initial order and predicted subsequent order(s) can be consolidated and delivered using a fewer number of shipments. More generally, embodiments of the present invention improve the art and solve at least the issues stated above by (i) receiving, by a computing device, a first order from a device of a user, a kiosk, or from a device associated with the shipping party or shopping platform; (ii) predicting when the user will place a second order based on historical data; (iii) delaying the shipment of the first order for a predetermined time period based on a predetermined threshold of probability a second order will be placed; and (iv) responsive to receiving the second order within a predetermined time frame, shipping the first order and the second order when the second order is received during the specified predetermined time period. It is important to note that embodiments of the present invention are accomplished while maintaining predetermined shipping and delivery timelines and the management of timely order fulfillments. For example, if the agreed shipping timeline is five days, then embodiments of the present invention will execute and maintain the five-day shipping agreement.

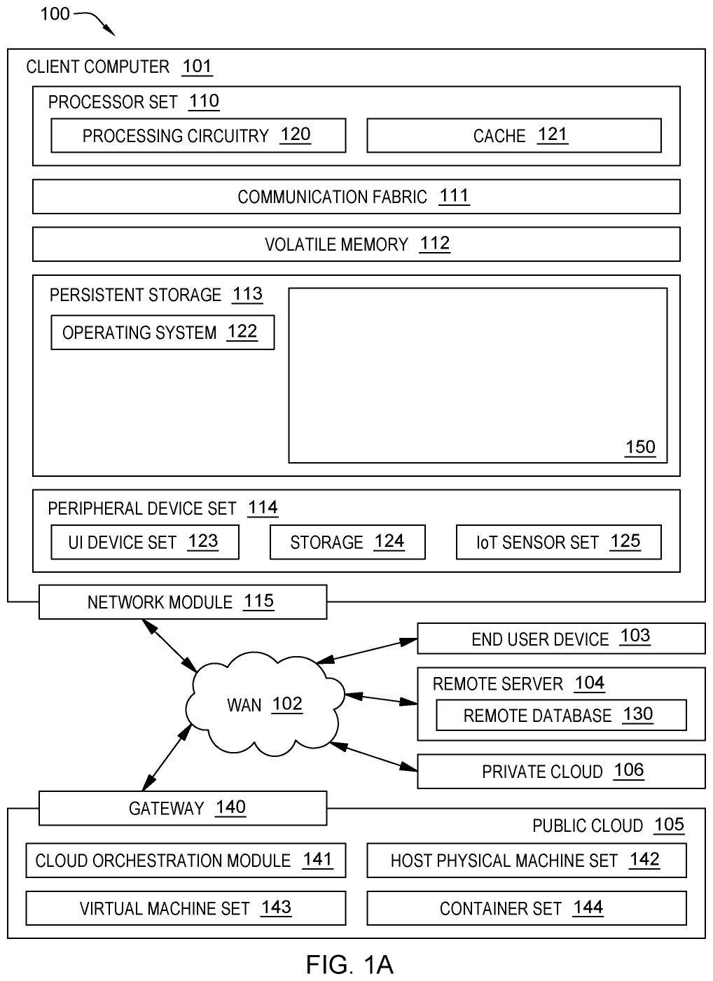

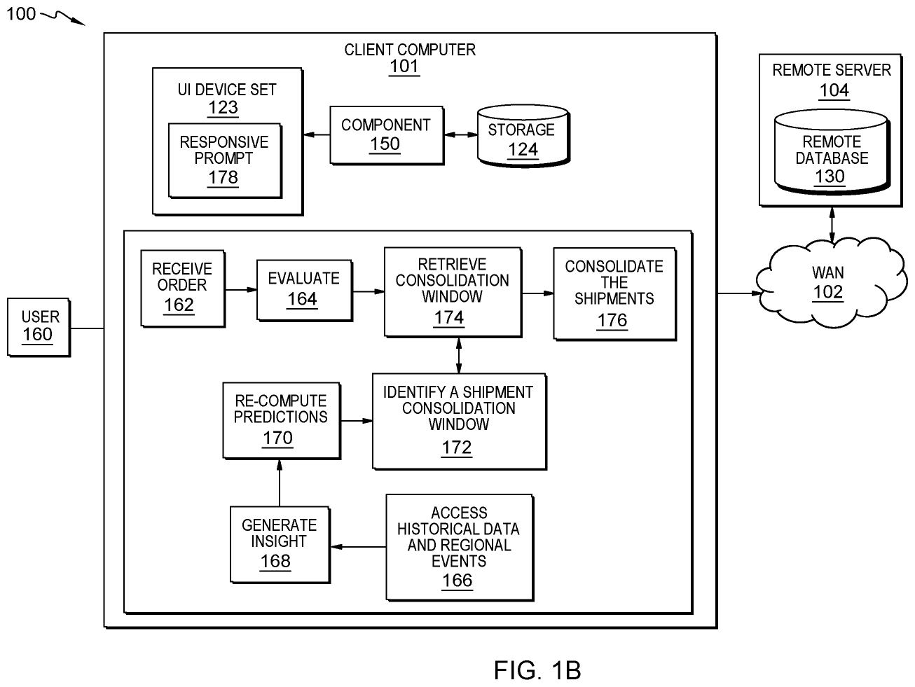

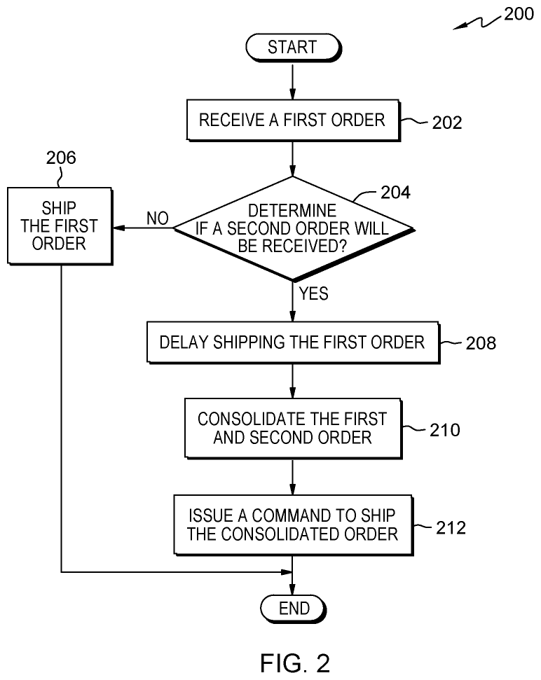

Implementation of embodiments of the invention may take a variety of forms, and exemplary implementation details are discussed subsequently with reference to the Figures (i.e., FIG. 1A-FIG. 2).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored for consolidating shipments to reduce carbon emissions and shipping costs and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as supply chain optimization program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Component 150 may determine, within a predetermined level of confidence, whether a user will place an additional order(s) (i.e., secondary order(s)) within a predetermined time threshold after placing an initial order. In various embodiments, if component 150 determines that a secondary order will be placed then component 150 executes a “hold” command that holds the shipment of the initial order for a predetermined amount of time, so that that the secondary order(s) can be consolidated and reduce the number of shipments. The hold command may withhold the order from the shipment/distribution center (herein after “shipping party”) for the predetermined amount of time. In some embodiments, component 150 issues a notification to the shipping party to hold the initial order from a predetermined amount of time and marks the initial order as “hold” or “do not fulfill” until the predetermined amount of time is reached. The predetermined amount of time maintains the predetermined shipping and delivery timeline of the initial order.

In various embodiments, component 150 predicts that at least one secondary order will be placed for a recipient (e.g., user) within a predetermined time threshold after an initial order has been placed for the recipient, wherein based on the prediction that the recipient is placing at least one secondary order component 150 holds the shipment associated with the initial order for the predetermined time threshold so that multiple orders (e.g., the initial order and the at least one secondary order) can be consolidated and delivered using a reduced number of shipments. For example, an order has been placed by a first customer for a recipient with a delivery date of December 12. In this example, component 150 identifies that there were 4 orders shipped to the recipient last year with a delivery date of December 12. Therefore, based on the delivery and order history, component 150 determines that it is likely, within a predetermined level of confidence, that other customers also will place orders to the recipient as well. Component 150 may predict and/or identify if a that at least one secondary order will be placed for a recipient based on historic purchase data (i.e., purchase/order history), user profile data (birthday, anniversary, address, etc.), user history, and order insights.

Component 150 may predict and apply a shipment consolidation window for an order based on user history and order insights derived using the data sources like, but not limited to, purchase history, browsing history, calendar events, internet of things (IoT) data, user profiles, social media data, and/or scheduled promotions. Purchase history, for example, is when a shopper generally places a monthly grocery order around the fifth, however, the monthly grocery order this month is placed on the fourth and contains only a fraction of the items typically purchased. Therefore, in this example, component 150 will determine that it is likely (i.e., anticipate) that a customer will place another order in next twenty-four hours for the remaining grocery items. Browsing history, for example, is when a shopper places an order for Oxygen Concentrator, and has been searching for voltage regulators, so it is very likely that customer will place another order in next few hours to complement the initial purchase (e.g., a voltage regulator). A calendar event, for example, is when a shopper places their typical monthly grocery on the fifth of the month; however, there is a party scheduled on the shopper's calendar for the sixth of the month, so it is very likely that the shopper will place another order in next twelve hours for the party related items. IoT data may be various data known in the art that is collected by IoT devices. For example, after placing an order for a mobile phone on a laptop, the shopper asks a smart device to suggest options for a protective cover for the purchased mobile phone. Therefore, in this example, component 150 analyzes the IoT data to determine that the customer will likely place another order for the mobile phone cover.

A profile may be a user profile that is generated based on user input and/or collected user data. For example, an order has been placed for a recipient with a delivery date of the second of April with is an annual event for the recipient. Therefore, in this example, based on the stored annual event in the recipient's profile, component 150 determines that other customers will likely place orders to be sent to the recipient. Another example is a wedding registry, wherein component 150 pauses all deliveries until the day of the wedding. Social media data may be data that is collected from user generated data on one or more social media platforms. For example, an order has been placed by a customer on an online shopping platform to be delivered to the customer's home. Coincidently, the customer also recently made a social media post asking the customer's followers if they could send him his favorite music compact discs (CDs), wherein the social media post received two replies from two followers stating that each of them would order those CDs later that evening from the same online shopping platform. Therefore, in this example, component 150 determines that it is likely that more orders will be placed and shipped to the customer's home. Upcoming promotions may be any scheduled discount promotion used in commerce to attract consumers and/or users. For example, a flat 10% promotion is scheduled to start midnight, therefore, based on the shopper's promotion redemption history, component 150 determines that the shopper is likely to place another order utilizing the promotion and pauses any previous orders for a predetermined amount of time.

In various embodiments, component 150 predicts and applies a predetermined shipment consolidation window for an order based on regional/local insights derived using data sources like, but not limited to, calendar events such as local holidays, and/or consumer trends. For example, a grocery store order is placed by a customer with a shipping date on a known national holiday. Based on collected customer data, component 150 identifies that the customer generally orders lunch on holidays so component 150 pauses the grocery store order in anticipation of the lunch order to consolidate the shipment. In various embodiments, component 150 may generate and output a responsive prompt after an order or after a predicted, identified, and/or received second order that queries the user to select whether the user consents to the consolidation of the orders. In another example, based on user search history and trending content, component 150 identifies that a natural disaster is likely occurring in a user's region and that consumers will likely stockpile items and place multiple orders.

Component 150 may identify and apply a shipment consolidation window for an order, based on fulfilment data and order details like, but not limited to, carrier service processing times. For example, same day delivery selected by the customer while placing an order. Another example is based on an urgency with which a user needs the order. In this example, a shopper placed an order for items to be used over the weekend, so the order can wait for consolidation by Thursday if shipment can be delivered in one day. In another example, component 150 uses sourcing locations to identify and apply a shipment consolidation window for an order. In this example, if one order is for digital items that are delivered directly to the user over the internet and a second anticipated order is a grocery store order that is shipping from the store, component 150 identifies that consolidation is not required for these orders.

Component 150 may identify and apply a predetermined shipment consolidation window for an order, based on catalogue insights at various levels like, but not limited to, item classification and item category. For example, items classified as refrigerated or hazardous may not be consolidated with other regular items. In another example, component 150 identifies that grocery and furniture orders cannot be combined, but apparel and stationary items can be combined.

For example, a user places a first order (order 1) around 10:00 pm on May 4, 2021, for body wash and shampoo from an online shopping platform (Order 1), with a next day delivery option, and the user places a second order (order 2) for hair conditioner around one hour after the placement of order 1 from the online shopping platform with a next day delivery option. Additionally, the user places a third order (order 3) the following morning around 7:00 am from the online shopping platform with a next day delivery option. In this example, component 150 is triggered by one or more orders placed by the user. In this example, component 150 reviews the purchasing history of the user and identifies that there are orders for household essentials such as body wash, shampoo, conditioner, toothpaste, hand sanitizer in the first week of every month, mostly around the fourth of every month. When the user places Order 1, component 150 determines that many of the monthly ordered items have not been ordered yet. Thus, component 150 derives that the user will most likely be placing order for other monthly purchased items by 11:59 AM on the fourth (almost two hours from the date of Order 1.

Continuing this example, component 150 identifies that the user has placed additional orders for additional items (though those items are not regularly bough by the user). Based on the delivery options selected by the user, component 150 identifies that the user does not need the grocery items urgently. Therefore, in this example, component 150 establishes the shipment consolidation window for the user's orders to close at 09:00 AM on May 5, 2021. In this example, though component 150 schedules Order 1 (to reserve the inventory for Order 1), component 150 places Order 1 on shipment consolidation hold for eleven hours. Similarly, though component 150 schedules Order 2 (to reserve the inventory for Order 2), component 150 places Order 2 on shipment consolidation hold for ten hours. Similarly, though component 150 schedules Order 3 (to reserve the inventory for Order 3), component 150 puts Order 3 on shipment consolidation hold for 2 hours. Therefore, at 9:00 am, a single shipment is initiated for all three orders, and it is delivered to the user by 1:00 PM, which results in reduced emissions and reduced shipping cost. Component 150 may generate and issue responsive prompts and/or alerts. In some embodiments, the issues responsive prompts and/or alerts are predetermined. For example, continuing the scenario above, component 150 may issue a notification to the user stating “Thank you “user” for choosing us for multiple orders! We are offering you a flat 5% discount on your next grocery order(s) that are all placed on the same day.” In various embodiments, component 150 enables and encourages users place multiple orders throughout the day as they identify new products, goods, or services that they need or want to potentially have bundled.

FIG. 1B is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1B provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes end user (user)160, client computer 101, and remote server 104 interconnected WAN 102.

In the depicted embodiment, component 150 receives an order 162 associated with user 160. Order 162 may be placed and/or received from multiple channels such as, but not limited to, call center, store, e-commerce websites, social media platforms, and/or smart service applications. In the depicted embodiment, component 150 evaluates 164 the received order (e.g., but not limited to order contents, quantity, components of the order, and user purchase history). In the depicted embodiment, component 150 retrieves a consolidation window 174. Component 150 access historical data and regional events 166 to generate insight 168. In the depicted embodiment, based on the generated insight 168, component 150 re-computes predictions 170 to identify a shipment consolidation window 172. For example, a temperature sensitive item (candy) is being shipped, but the shipment is occurring during winter, so component 150 would not need to recompute a special handling; however, if the order occurring during the summer months, the component 150 would need to recompute and the dry ice-cold pack requirement would be triggered. In the depicted embodiment, based on the retrieved consolidation window 174, component 150 consolidates the two or more shipments. Shipment consolidation may be consolidated based on a shipment consolidation predictor.

Shipment Consolidation Predictor can be configured (to include/exclude) at a predetermined level such as, but not limited to, item category (etc. apparel, toys, home essentials, etc.), item classification (e.g., edible, inedible, etc.), and item type (sporting goods, groceries, medicine, home goods, etc.). Shipment Consolidation predictor also may be associated with specific markets (e.g., Shipment Consolidation Predictor may be required only for the orders fulfilled in California and are not required for the orders fulfilled in North Dakota) and/or selling channels, because the shipment consolidation windows for a specific selling channel may be more tolerable compared to the others in some cases (e.g., an online retail platform configures lower or no maximum shipment consolidation window for orders at it corresponding stores whereas a higher one for the ecommerce orders.). It is important to note that the provided examples are merely simplified examples and component 150 may be utilized by large shipping distributors to manage transcontinental shipping orders.

In various embodiments, the retrieved consolidation window 174, not depicted in FIG. 1B, may comprise a maximum shipment consolidation window that may be configured at a predetermined level such as, but not limited to, item category, item classification, item, carrier service, order channel, and/or order date duration. In various embodiments, not depicted in FIG. 1B, to consolidate the shipments 176, component 150 utilizes calendar data availability, wherein calendar data availability is data available on the calendar events accessible through multiple internal and external sources, user purchasing habits (e.g., Orders placed by customer in the past, Orders placed by other customers in the customers region, and orders placed for the similar items in the past), predetermined shipping parameters (e.g., expected delivery and shipment dates, carrier service processing times, do not mix constraints, ship from locations, ship to locations, and duration of transit time for stated date delivery).

FIG. 2 illustrates operational steps of component 150, generally designated 200, in communication with client computer 101, remote server 104, private cloud 106, EUD 103, and/or public cloud 105, within distributed data processing environment 100, for consolidating two or more shipments, in accordance with an embodiment of the present invention. FIG. 2 provides an illustration of one implementation and does not imply any limitations with regard to the environments in which different embodiments may be implemented. Many modifications to the depicted environment may be made by those skilled in the art without departing from the scope of the invention as recited by the claims.

In step 202, component 150 receives a first order. In various embodiments, component 150 receives a first order associated with a user. Component 150 may receive a first order from a device of a user, a kiosk, or from a device associated with the shipping party or shopping platform. In various embodiments the recipient may also be the user.

In step 204, component 150 determines if a second order will be received. In various embodiments, component 150 determines with a predetermined degree of confidence that one or more additionally orders will be placed, within a predefined timeframe, that are associated with the user. In the depicted embodiment, if component 150 determines, within a predetermined degree of confidence, that a second order, associated with the user, will be placed within a predefined timeframe (Yes step) then component 150 advances to step 208. However, in the depicted embodiment, if component 150 determines, within or outside of a predetermined degree of confidence, that a second order, associated with the user, will not be placed within a predefined timeframe or that no second order is received within the predefined timeframe (No step) then component 150 advances to step 206.

In step 206, component 150 ships the first order. In various embodiments, responsive to the predefined timeframe expiring and/or determining, within a predetermined confidence level, that no secondary orders will be placed, component 150 ships the first order based on the received shipping instructions.

In step 208, component 150 delays shipping the first order. In various embodiments, responsive to determining a second order will be placed associated with the user, component 150 delays the first order for a predefined timeframe.

In step 210, component 150 consolidates the first order and second order. In various embodiments, responsive to receiving a second order within the predefined timeframe, component 150 consolidates the first order and second order into one shipment.

In step 212, component 150 issues a command to ship the consolidated order. In various embodiments, component 150 issues a command to ship the consolidated order to the designated recipient (i.e., user).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for consolidating two or more shipments, the computer-implemented method comprising:
receiving, by a computing device, a first order associated with a user;
determining, within predetermine range of confidence, that a second order associated with the user will be received within a predefined timeframe; and
delaying the shipment of the first order, for a predetermined amount of time, based on the determination the second order will be received, wherein delaying the shipment of the first order comprises:
executing a hold command that withholds the first order from a distribution center for the predetermined amount of time; and
responsive to receiving the second order within the predefined timeframe, consolidating the first order and the second order into a consolidated order.

2. The computer-implemented method of claim 1, further comprising:
executing a command to ship the consolidated order.

3. The computer-implemented method of claim 1, further comprising:
responsive to the not receiving the second order within the predefined timeframe, shipping the first order.

4. The computer-implemented method of claim 1, further comprising:
displaying, by a client device, a responsive prompt to that queries the user to consent to a consolidation the first order and the second order.

5. The computer-implemented method of claim 1, further comprising:
predicting and applying a shipment consolidation window for the first order based on user history, and order insights derived using purchase history, browsing history, calendar events, internet of things (IoT) data, user profiles, social media data, and scheduled promotions.

6. The computer-implemented method of claim 1, wherein delaying the shipment of the first order further comprises:
executing a hold command that instructs a fulfillment center or shipping center to hold a shipment or fulfilment of the first order for predetermined time, with respect to the predefined timeframe, so that that the second order and the first order can be consolidated.

7. The computer-implemented method of claim 1, further comprising:
identifying and applying a shipment consolidation window for the first order, based on fulfilment data and order details.

8. A computer system for consolidating two or more shipments, the computer system comprising:
one or more computer processors;
one or more computer readable storage devices; and
program instructions stored on the one or more computer readable storage devices for execution by at least one of the one or more computer processors, the stored program instructions comprising:
program instructions to receive, by a computing device, a first order associated with a user; and
program instructions to determine, within predetermine range of confidence, that a second order associated with the user will be received within a predefined timeframe;
program instructions to delay the shipment of the first order, for a predetermined amount of time, based on the determination the second order will be received, wherein delaying the shipment of the first order comprises:
program instructions to execute a hold command that withholds the first order from a distribution center for the predetermined amount of time; and
responsive to receiving the second order within the predefined timeframe, program instructions to consolidate the first order and the second order into a consolidated order.

9. The computer system of claim 8, further comprising:
program instructions to execute a command to ship the consolidated order.

10. The computer system of claim 8, further comprising:
responsive to the not receiving the second order within the predefined timeframe, program instructions to ship the first order.

11. The computer system of claim 8, further comprising:
program instructions to display, by a client device, a responsive prompt to that queries the user to consent to a consolidation of the first order and the second order.

12. The computer system of claim 8, further comprising:
program instructions to predict and apply a shipment consolidation window for the first order based on user history, and order insights derived using purchase history, browsing history, calendar events, internet of things (IoT) data, user profiles, social media data, and scheduled promotions.

13. The computer system of claim 8, wherein delaying the shipment of the first order comprises:
program instructions to execute a hold command that instructs a fulfillment center or shipping center to hold a shipment or fulfilment of the first order for predetermined time, with respect to the predefined timeframe, so that that the second order and the first order can be consolidated.

14. The computer system of claim 8, further comprising:
program instructions to identify and apply a shipment consolidation window for the first order, based on fulfilment data and order details.

15. A computer program product for consolidating two or more shipments, the computer program product comprising:
one or more computer readable storage devices and program instructions stored on the one or more computer readable storage devices, the stored program instructions comprising:
program instructions to receive, by a computing device, a first order associated with a user;
program instructions to determine, within predetermine range of confidence, that a second order associated with the user will be received within a predefined timeframe;
program instructions to delay the shipment of the first order, for a predetermined amount of time, based on the determination the second order will be received, wherein delaying the shipment of the first order comprises:
program instructions to execute a hold command that withholds the first order from a distribution center for the predetermined amount of time; and
responsive to receiving the second order within the predefined timeframe, program instructions to consolidate the first order and the second order into a consolidated order.

16. The computer program product of claim 15, further comprising:
program instructions to execute a command to ship the consolidated order.

17. The computer program product of claim 15, further comprising:
responsive to the not receiving the second order within the predefined timeframe, program instructions to ship the first order.

18. The computer program product of claim 15, further comprising:
program instructions to display, by a client device, a responsive prompt to that queries the user to consent to a consolidation of the first order and the second order.

19. The computer program product of claim 15, further comprising:
program instructions to predict and apply a shipment consolidation window for the first order based on user history, and order insights derived using purchase history, browsing history, calendar events, internet of things (IoT) data, user profiles, social media data, and scheduled promotions.

20. The computer program product of claim 15, wherein delaying the shipment of the first order comprises:
program instructions to execute a hold command that instructs a fulfillment center or shipping center to hold a shipment or fulfilment of the first order for predetermined time, with respect to the predefined timeframe, so that that the second order and the first order can be consolidated.
